(19) United States
(12) Patent Application Publication
(10) Pub. No.: US 2023/0226497 A1
(43) Pub. Date: Jul. 20, 2023

(54) FORWARD OSMOSIS MEMBRANE HAVING LOW WATER RESISTANCE AND EXCELLENT MECHANICAL STRENGTH

(71) Applicant: National Tsing Hua University, Hsinchu City (TW)

(72) Inventors: Nyan-Hwa TAI, Hsinchu City (TW); Yen-Wen HUANG, Hsinchu City (TW); Chi-Young LEE, Hsinchu City (TW)

(21) Appl. No.: 17/868,342

(22) Filed: Jul. 19, 2022

(30) Foreign Application Priority Data
Jan. 18, 2022 (TW) 111102014

(51) Int. Cl. B01D 69/10; B01D 61/00; B01D 69/02; B01D 71/56; B01D 71/64

(52) U.S. Cl. CPC B01D 69/108; B01D 61/0022; B01D 69/02; B01D 69/107; B01D 71/56; B01D 71/641; B01D 2325/04; B01D 2325/24

(57) ABSTRACT

A forward osmosis membrane having a low water resistance and an excellent mechanical strength includes a support unit and a selective layer. The support unit includes a plurality of nanostructures, and has opposite first and second surfaces which are defined by the nanostructures. Each of the nanostructures includes a carbon nanotube and a hydrophilic film coated around the carbon nanotube. The hydrophilic film includes a first hydrophilic polymeric material and a second hydrophilic polymeric material. The second hydrophilic polymeric materials of the nanostructures are cross-linked. The selective layer covers and contacts the first surface of the support unit.

### CROSS-REFERENCE TO RELATED APPLICATION

This application claims priority of Taiwanese Invention Patent Application No. 111102014, filed on Jan. 18, 2022.

### FIELD

The present disclosure relates to an osmosis membrane, and more particularly to a forward osmosis membrane having a low water resistance and an excellent mechanical strength.

### BACKGROUND

Reverse osmosis has been widely used in recent decades to remove contaminants from water source so as to achieve the purpose of water purification. However, application of an external pressure to overcome osmotic pressure during reverse osmosis might result in an increased energy consumption. On the contrary, no external pressure is necessary in a forward osmosis process, which utilizes an osmotic pressure gradient formed by a difference of solutes concentration on two sides of a selectively permeable membrane for purifying water. Therefore, in recent years, technologies related to forward osmosis has become a mainstream of water purification research in the industry. A conventional forward osmosis membrane includes a backing layer, a polymeric support layer formed on the backing layer, and a selective layer formed on the polymeric support layer.

Referring to FIG. 1, Chinese Invention Patent Publication No. CN 101821089 B discloses a composite semi-permeable membrane 1 which includes a non-woven fabric support layer 11, a polymer layer 12 formed on the non-woven fabric support layer 11, and a skin layer 13 formed on the polymer layer 12. The non-woven fabric support layer 11 may be made from polyamide or polyacrylonitrile. The polymer layer 12 has a plurality of nanotubes 121 dispersed therein, and is a polyamide film formed by interfacial copolymerization of a polyfunctional amine solution and a polyfunctional acid halide solution. The skin layer 13 is a remnant of the interfacial copolymerization reaction.

Referring to FIG. 2, Korean Invention Patent Application Publication No. 10-2017-0092132 discloses an ultra-thin carbon nanotube composite separator 2 for forward osmosis. The ultra-thin carbon nanotube composite separator 2 includes a non-woven fabric support (not shown), a support film 21 formed on the non-woven fabric support, and a selective layer 22 formed on the support layer 21.

The support layer 21 is made of polyimide, and the selective layer 22 includes a polyimide film 221 having a plurality of hydrophilic carbon nanotubes 222 dispersed therein.

To be specific, the non-woven fabric support layer 11 of the composite semi-permeable membrane 1 shown in FIG. 1 and the non-woven fabric support of the ultra-thin carbon nanotube composite separator 2 shown in FIG. 2 aim to provide mechanical strength to the overall structure, such that the composite semi-permeable membrane 1 and the ultra-thin carbon nanotube composite separator 2, when using for prolonged period of time, are able to withstand force generated by fluid flow, thereby avoiding structural damage. Although the composite semi-permeable membrane 1 and the ultra-thin carbon nanotube composite separator 2 could be used in forward osmosis for purifying water, the non-woven fabric support layer 11 of the composite semi-permeable membrane 1 and the non-woven fabric support of the ultra-thin carbon nanotube composite separator 2 may cause undesired resistance to the permeation of water molecules. In addition, the pores of the non-woven fabric support layer 11 and the non-woven fabric support of the ultra-thin carbon nanotube composite separator 2 might also be easily clogged by large-sized solutes in the water, resulting in contaminants not being effectively removed from the water.

Therefore, there is a need for those skilled in the art to develop a forward osmosis membrane which can not only solve the aforesaid problems such as undesired water resistance and clogging caused by large-sized solutes, but also has an excellent mechanical strength.

### SUMMARY

Therefore, an object of the present disclosure is to provide a forward osmosis membrane having a low water resistance and an excellent mechanical strength which can alleviate at least one of the drawbacks of the prior art.

According to the present disclosure, the forward osmosis membrane includes a support unit and a selective layer. The support unit includes a plurality of nanostructures, and has opposite first and second surfaces which are defined by the structures. Each of the nanostructures includes a carbon nanotube and a hydrophilic film coated around the carbon nanotube. The hydrophilic film includes a first hydrophilic polymeric material and a second hydrophilic polymeric material. The second hydrophilic polymeric materials of the nanostructures are cross-linked. The selective layer covers and contacts the first surface of the support unit.

### BRIEF DESCRIPTION OF THE DRAWINGS

Other features and advantages of the present disclosure will become apparent in the following detailed description of the embodiments with reference to the accompanying drawings, of which:

FIG. 1 is a schematic view illustrating a composite semi-permeable membrane disclosed in Chinese Invention Patent Publication No. CN 101821089 B;

FIG. 2 is a schematic view illustrating an ultra-thin carbon nanotube composite separator disclosed in Korean Invention Patent Application Publication No. 10-2017-0092132;

FIG. 3 is a fragmentary schematic view illustrating a first embodiment of a forward osmosis membrane according to the present disclosure;

FIG. 4 is a partially enlarged fragmentary view of FIG. 3, illustrating a detailed structure of a support unit and a selective layer of the first embodiment of the forward osmosis membrane according to the present disclosure;

FIG. 5 is a partially enlarged fragmentary view illustrating a detailed structure of the support unit and the selective layer of a second embodiment of the forward osmosis membrane according to the present disclosure;

FIGS. 6 and 7 are perspective views illustrating consecutive steps for making the forward osmosis membrane (pCNT_{y}/PVA-PA) of Example 1 (EX1);

FIG. 8 is a perspective view illustrating procedures for making the support unit (pVAₐpCNT_{z}) of the forward osmosis membrane (pVAₐpCNT_{z}-PA) of Example 2 (EX2);

FIG. 9 is a perspective view illustrating procedures for making the support unit (TCNTₓ/PVA) of the forward osmosis membrane of Comparative Example 1 (CE1);

FIG. 10 is a scanning electron microscope (SEM) image illustrating a cross-section of the pCNT₅/PVA-PA forward osmosis membrane of EX1;

FIG. 11 is an SEM image illustrating a cross-section of the pCNT₁₀/PVA-PA forward osmosis membrane of EX1;

FIG. 12 is an SEM image illustrating a cross-section of the pVA_{0.25}pCNT₃-PA forward osmosis membrane of EX2;

FIG. 13 is a graph illustrating Raman spectra of the support units of the forward osmosis membranes of EX1 and CE1 before formation of the selective layer;

FIG. 14 is a graph illustrating Fourier Transform Infrared (FTIR) spectra of the support units of the forward osmosis membranes of EX1, EX2 and CE1 before formation of the selective layer;

FIG. 15 is a transmission electron microscope (TEM) image of commercially available carbon nanotubes (TCNT);

FIG. 16 is a TEM image illustrating a carbon nanotube of the forward osmosis membrane of EX1 around which a hydrophilic film containing auto-polymerized polydopamine is coated;

FIG. 17 is a graph of water contact angle versus time illustrating hydrophilicity of the support unit of a respective one of the forward osmosis membranes of EX1, EX2 and CE1 before formation of the selective layer;

FIG. 18 is a graph illustrating FTIR spectra of the forward osmosis membrane of EX2 before and after formation of the selective layer (PA);

FIG. 19 is a photograph showing the forward osmosis membrane (TCNT₃-PA) of Comparative Example (CE2) after a forward osmosis performance test is conducted under a forward osmosis (FO) mode using a cross-flow system for 2 hours;

FIG. 20 is a photograph showing the forward osmosis membrane of EX2 (PVA_{0.25}pCNT₃-PA) after the forward osmosis performance test is conducted under the FO mode using the cross-flow system for 2 hours;

FIG. 21 is a bar graph illustrating a comparison of forward osmosis efficiency (water flux and reverse solute flux) determined at 20° C. and 28° C. for three forward osmosis membranes (pCNT₁₀/PVA-PA, pCNT₂₀/PVA-PA and pCNT₃/PVA-PA) of EX1 which are prepared using different filtration amounts of pCNT;

FIG. 22 is a bar graph illustrating a comparison of forward osmosis efficiency at 28° C. for three forward osmosis membranes (TCNT₁₀/PVA-PA, TCNT₂₀/PVA-PA and TCNT₃₀/PVA-PA) of CE1 which are prepared using different filtration amounts of TCNT;

FIG. 23 is a bar graph illustrating a comparison of forward osmosis efficiency at 28° C. for four forward osmosis membranes (pCNT₅/PVA-PA, pCNT₁₀/PVA-PA, pCNT₂₀/PVA-PA and pCNT₃₀/PVA-PA) of EX1 which are prepared using different filtration amounts of pCNT;

FIG. 24 is a bar graph illustrating a comparison of forward osmosis efficiency at 28° C. for three forward osmosis membranes (PVA₁pCNT₃-PA, PVA₁pCNT₅-PA and PVA₁pCNT₁₀-PA) of EX2 which are prepared using different filtration amounts of PVApCNT;

FIG. 25 is a bar graph illustrating a comparison of forward osmosis efficiency at 28° C. for four forward osmosis membranes (PVA_{0.25}pCNT₃-PA, PVA_{1.0}pCNT₃-PA, PVA_{1.5}pCNT₃-PA and PVA_{2.0}pCNT₃-PA) of EX2 which are prepared using different PVA amounts;

FIG. 26 is a bar graph illustrating a comparison of forward osmosis efficiency at 28° C. for each of the forward osmosis membranes of CE1 (TCNTₓ/PVA-PA), EX1 (pCNT_{y}/PVA-PA), and EX2 (pVAₐpCNT_{z}-PA); and

FIG. 27 is a bar graph illustrating water flux (Jw) and reverse solute flux (Js) of the forward osmosis membrane of EX2 (PVA_{0.25}pCNT₃-PA) tested under the FO mode and pressure-retarded osmosis (PRO) mode in a draw solution containing a corresponding one of salt concentrations.

### DETAILED DESCRIPTION

It is to be understood that, if any prior art publication is referred to herein, such reference does not constitute an admission that the publication forms a part of the common general knowledge in the art, in Taiwan or any other country.

For the purpose of this specification, it will be clearly understood that the word “comprising” means “including but not limited to”, and that the word “comprises” has a corresponding meaning.

Unless otherwise defined, all technical and scientific terms used herein have the meaning commonly understood by a person skilled in the art to which this disclosure belongs. One skilled in the art will recognize many methods and materials similar or equivalent to those described herein, which could be used in the practice of this disclosure. Indeed, this disclosure is in no way limited to the methods and materials described.

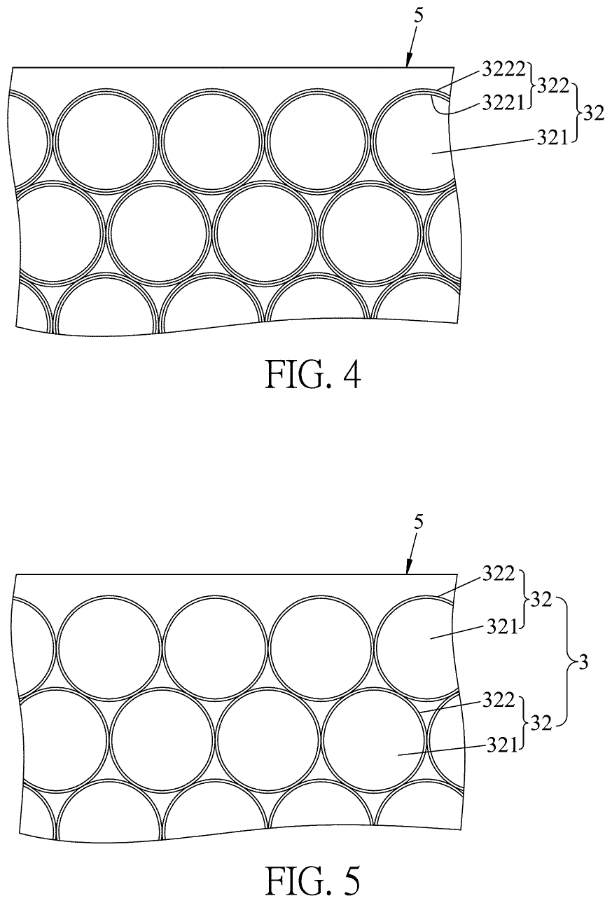

Referring to FIGS. 3 and 4, a first embodiment of a forward osmosis membrane having a low water resistance and an excellent mechanical strength according to the present disclosure includes a support unit 3 and a selective layer 5.

The support unit 3 includes a plurality of nanostructures 32, and has opposite first and second surfaces 31, 31′ which are defined by the nanostructures 32. Each of the nanostructures 32 includes a carbon nanotube 321 and a hydrophilic film 322 coated around the carbon nanotube 321. The hydrophilic film 322 includes a first hydrophilic polymeric material and a second hydrophilic polymeric material. The second hydrophilic polymeric materials of the nanostructures 32 are cross-linked. In this embodiment, for each of the nanostructures 32, the first hydrophilic polymeric material of the hydrophilic film 322 is formed into a first hydrophilic polymeric layer 3221 that is coated around the carbon nanotube 321, and the second hydrophilic polymeric material is formed into a second hydrophilic polymeric layer 3222 that is coated around the first hydrophilic polymeric layer 3221.

For each of the nanostructures 32, the first hydrophilic polymeric material of the hydrophilic film 322 may be selected from the group consisting of polydopamine (PDA), poly(acrylic acid), polyaniline, polycaprolactone, and combinations thereof. For each of the nanostructures 32, the second hydrophilic polymeric material of the hydrophilic film 322 may be selected from the group consisting of poly(vinyl alcohol) (PVA), polysulfone, polyether sulfone, and combinations thereof. The second hydrophilic polymeric materials of the nanostructures 32 are cross-linked by a cross-linking agent. Examples of the cross-linking agent may include, but are not limited to, glutaraldehyde (GA), N,N′methylenebisacrylamide, and a combination thereof.

It should be noted that, in the first embodiment, the second hydrophilic polymeric layer 3222 and the first hydrophilic polymeric layer 3221 coated around each of the nanostructures 32 are configured to increase a contact area of the forward osmosis membrane and a fluid (e.g., water), and a three-dimensional network structure formed by cross-linking of the second hydrophilic polymeric materials in the second hydrophilic polymeric layer 3222 provides an improved mechanical strength, such that the forward osmosis membrane of this disclosure is able to withstand force generated by fluid flow for a long period of time, thereby avoiding structural damage.

The selective layer 5 covers and contacts the first surface 31 of the support unit 3. The selective layer 5 may be made of a polymeric material selected from the group consisting of polyamide (PA), poly(amide-imide), poly(piperazine-amide), and combinations thereof. In the first embodiment, the first hydrophilic polymeric material is PDA, the second hydrophilic polymeric material is PVA, the cross-linking agent is GA, and the selective layer 5 is made of PA, but are not limited thereto.

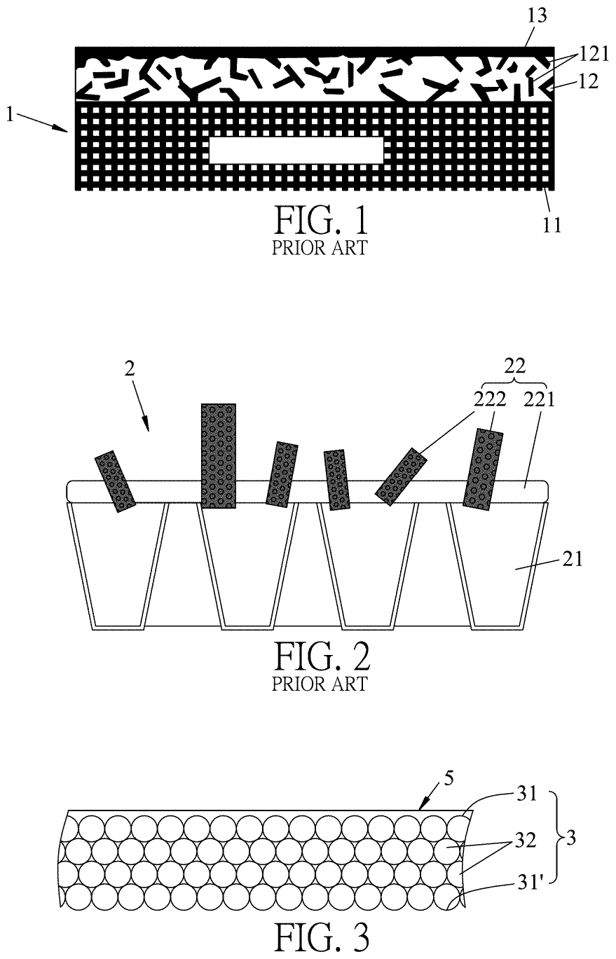

In certain embodiments, the second surface 31′ is an exposed surface. By virtual of the support unit 3 forming the three-dimensional network structure through cross-linking of the second hydrophilic polymeric materials in the second hydrophilic polymeric layers 3222 of the nanostructures 32, the forward osmosis membrane of this disclosure may be free from a support layer made of a non-woven fabric that is used in a conventional forward osmosis membrane as shown in FIG. 1 or 2, and can still maintain a sufficient mechanical strength. In certain embodiments, the forward osmosis membrane substantially consists of the support unit 3 and the selective layer 5. In other embodiments, the forward osmosis membrane consists of the support unit 3 and the selective layer 5.

In certain embodiments, the forward osmosis membrane has a thickness ranging from 1.0 μm to 35.0 μm. In the first embodiment, the thickness of the forward osmosis membrane ranges from 3.5 μm to 33.9 μm.

Referring to FIGS. 3 to 5, a second embodiment of the forward osmosis membrane is substantially the same as the first embodiment, except that the hydrophilic film 322 of the nanostructure 32 of the second embodiment has a configuration different from that of the hydrophilic film 322 of the nanostructure 32 of the first embodiment.

To be specific, the hydrophilic film 322 of the nanostructure 32 is formed as a single-layer structure, i.e., a hydrophilic polymeric layer, which is different from the double-layered structure of the first embodiment, i.e., the first hydrophilic polymeric layer 3221 and the second hydrophilic polymeric layer 3222. In other words, in the second embodiment, each of the nanostructures 32 includes the carbon nanotube 321 and the hydrophilic polymeric layer 322 which is coated around the carbon nanotube 321 and which is formed from the first hydrophilic polymeric material and the second hydrophilic polymeric material. The second hydrophilic polymeric materials of the hydrophilic polymeric layer 322 of the second embodiment are cross-linked. The selective layer 5 only covers and contacts the first surface 31 of the support unit 3.

The present disclosure will be further described by way of the following examples. However, it should be understood that the following examples are intended solely for the purpose of illustration and should not be construed as limiting the present disclosure in practice.

### EXAMPLES

The sources of the chemicals used in the following examples are listed below:
1. Tris(hydroxymethyl) aminomethane (hereinafter abbreviated as Tris) having 99.8% purity was purchased from Acros Organics.
2. Dopamine hydrochloride having >99.9% purity was purchased from Sigma-Aldrich.
3. Multi-walled carbon nanotube (TCNT) dispersion was purchased from Taiwan Carbon Nanotube Technology Corporation (Catalogue no.: CDW-381).
4. Poly(vinyl alcohol) (hereinafter abbreviated as PVA) powder having 99% purity was purchased from Sigma-Aldrich.
5. Glutaraldehyde (GA) having 25.0% purity was purchased from Alfa Aesar.
6. M-phenylenediamine (hereinafter abbreviated as MPD) having 99% purity was purchased from Sigma-Aldrich.
7. Trimesoly chloride (hereinafter abbreviated as TMC) having 98.0% was purchased from Alfa Aesar.
8. N-hexane (text formula: [CH₃(CH₂)₄CH₃]) having 99% purity was purchased from Macron Fine Chemicals.
9. Mixed cellulose ester filter paper (hereinafter abbreviated as MCE filter paper) having a pore size of 0.2 μm and a diameter of 9 cm was purchased from Advantec MFS (Catalogue no.: A020A090C).

### Example 1 (EX1)

The forward osmosis membranes of E1 have a configuration of the first embodiment as shown in FIG. 4, and were manufactured by consecutive steps as described below.

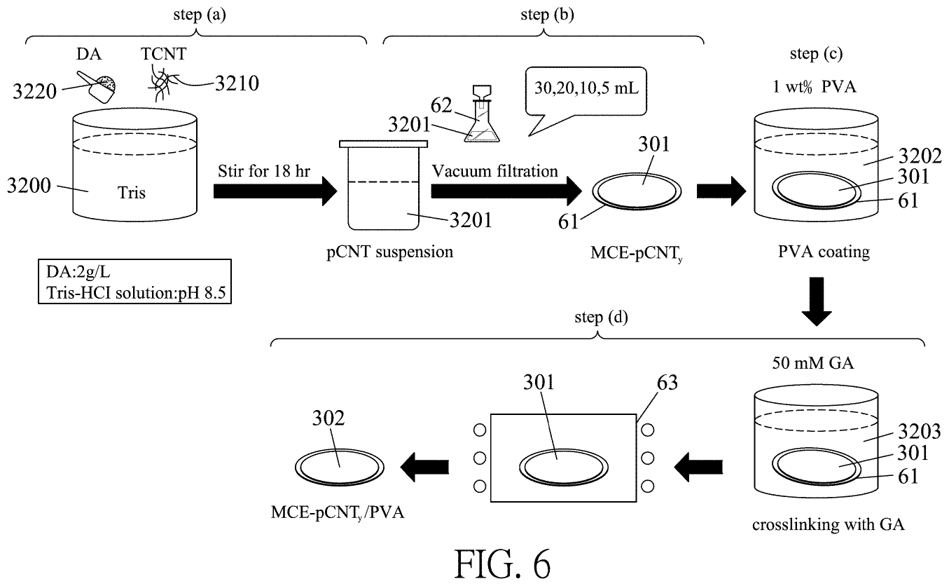

Referring to FIG. 6, in step (a), a suspension 3201 of polydopamine (PDA)-coated carbon nanotubes (hereinafter abbreviated as pCNT) was prepared. That is, dopamine (DA) is first provided in weak base environment so that the dopamine is allowed to be polymerized on surfaces of the carbon nanotubes so as to form a PDA layer thereon. To be specific, 1.21 g of Tris and 1 L of deionized water were mixed to form a Tris solution, and then 1 M of hydrochloric acid (HCl) was added into the Tris solution while adjusting pH of the Tris solution until the pH thereof reached 8.5, so as to obtain a 10 mM weak base buffer (i.e., Tris-HCl buffer). Next, 2 g of dopamine hydrochloride 3220 was mixed with 1 L of Tris-HCl buffer to obtain a brown color dopamine solution. Thereafter, a multi-walled carbon nanotube (TCNT) dispersion 3210 was added into the dopamine solution with a weight ratio of the TCNT dispersion 3210 to the dopamine solution of 1:5.5, so as to form a buffer solution 3200. Then, the buffer solution 3200 was stirred using a magnetic stirrer at 28° C. in the dark for 18 hours to permit the dopamine (DA) in the buffer solution 3200 to undergo auto-polymerization, so that the PDA layer is formed and coated around a surface of each of the carbon nanotubes (pCNT), thereby forming the pCNT suspension 3201.

In step (b), a preform body is prepared from pCNT and a mixed cellulose ester (MCE) filter 61 via vacuum filtration process. Specifically, four MCE filter papers 61 were individually placed in vacuum filters 62, and then a corresponding one of filtration amounts of the pCNT suspension 3201 (i.e., 30 mL, 20 mL, 10 mL and 5 mL) was poured thereon, followed by performing vacuum filtration, thereby forming four MCE-pCNT_{y} preform bodies 301 (i.e., pCNT remained on the MCE) in which “y” represents the filtration amount during the vacuum filtration process (i.e., y is 30, 20, 10 or 5). Thereafter, each of the MCE-pCNT_{y} preform bodies 301 was dried in an oven (not shown) at 80° C. for 5 minutes, and then left overnight to ensure complete evaporation of water therefrom.

In step (c), a poly(vinyl alcohol) (PVA) layer is formed on the preform body via a PVA coating process. To be specific, 1 wt % PVA aqueous solution 3202 was prepared by stirring PVA powder in water at 95° C. until completely dissolved. The dried MCE-pCNT_{y} preform bodies 301 obtained in step (b) were immersed in the 1 wt % PVA aqueous solution 3202 at 95° C. for 30 minutes, following by drying in the oven at 80° C. for 10 minutes, so as to coat the PVA layer thereon. In step (d), a cross-linking treatment is conducted to crosslink PVA. Specifically, the four dried PVA-coated preform bodies 301 obtained in step (c) were immersed in a glutaraldehyde (GA) solution 3203 containing 50 mM of GA and 20 mM of HCl for 1 hour to allow cross-linking of PVA, and then dried in an oven 63 at 80° C. for 10 minutes, thereby obtaining four MCE-pCNT_{y}/PVA films 302.

Further referring to FIG. 4, by performing the aforesaid steps (a) to (d), a plurality of the nanostructures 32 of the support unit 3 are obtained. Each of nanostructures 32 includes a corresponding one of the carbon nanotubes 321 on which the PDA layer serving as the first hydrophilic polymeric layer 3221 is coated around to form pCNT and the PVA layer which serves as the second hydrophilic polymeric layer 3222 is coated around the PDA layer, and PVA in the second hydrophilic polymeric layers 3222 of adjacent ones of the nanostructures 32 are cross-linked. Therefore, a three-dimensional network structure formed thereby can reduce voids formed between adjacent ones of the nanostructures 32 (i.e., reduce the probability of forming voids on the first surface 31 (i.e., upper surface) of the support layer 3), thereby avoiding undesired effect on the subsequent formation of the selective layer 5.

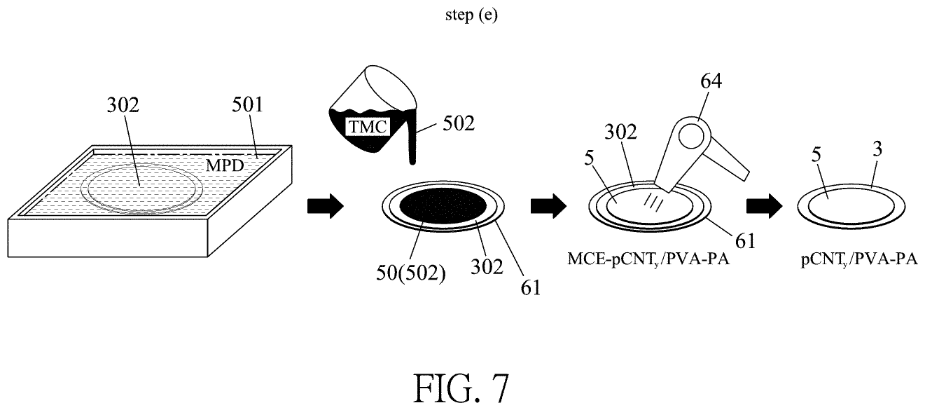

Further referring to FIG. 7, in step (e), a polyamide (PA) layer (i.e., the selective layer 5) is formed to cover the support unit 3. Specifically, water-soluble MPD and liquid-soluble TMC were respectively completely dissolved in deionized water and n-hexane under sonication using ultrasonic oscillator for 1 hour, so as to obtain a 1 wt % MPD aqueous solution 501 and a 0.3 wt % TMC organic solution 502. Each of the four MCE-pCNT_{y}/PVA films 302 obtained in step (d) was immersed in deionized water for 5 minutes, and then placed on a glass plate (not shown), followed by rolling an upper surface of each of the MCE-pCNT_{y}/PVA films 302 using an acrylic stick (not shown) until excess water droplets was removed. Thereafter, each of the MCE-pCNT_{y}/PVA films 302 was immersed in the MPD aqueous solution 501 for 5 minutes to absorb the MPD aqueous solution 501, and then placed on the glass plate (not shown), followed by rolling the upper surface of each of the MCE-pCNT_{y}/PVA film 302 using the acrylic stick until excess MPD aqueous solution 501 on the upper surface was removed. Next, peripheral region of each of the MCE-pCNT_{y}/PVA films 302 were fixed to a mold (not shown), and the TMC organic solution 502 was poured onto the upper surface of the MCE-pCNT_{y}/PVA film 302 to initiate an interfacial polymerization reaction for 2 minutes, so as to form the polyamide (PA) layer 50 on the upper surface of each of the MCE-pCNT_{y}/PVA films 302. Subsequently, the residual TMC organic solution 502 was removed, and the PA layer 50 thus formed was heated by a dryer 64 which supplied hot air at 64° C. for 10 minutes to increase cross-linking of polymer chains in the PA layer 50 to from the selective layer 5 on the MCE-pCNT_{y}/PVA films 302. Finally, the selective layer 5 of each of the resultant products was placed in deionized water, and then the MCE filter paper 61 on each of the MCE-pCNT_{y}/PVA films 302 was gently removed using tweezers, thereby obtaining four forward osmosis membranes (pCNT_{y}/PVA-PA) of EX1, i.e., pCNT₃₀/PVA-PA forward osmosis membrane, pCNT₂₀/PVA-PA forward osmosis membrane, pCNT₁₀/PVA-PA forward osmosis membrane, and pCNT₅/PVA-PA forward osmosis membrane.

It should be noted that, use of the acrylic stick to remove excess MPD aqueous solution 501 on the upper surface of the MCE-pCNT_{y}/PVA film 302 aims to minimize the MPD aqueous solution 501 penetrating into the portion of the MCE-pCNT_{y}/PVA film 302 away from the upper surface, so that the interfacial polymerization reaction at the surface of the MCE-pCNT_{y}/PVA film 302 would not be adversely affected. Therefore, in each of the pCNT_{y}/PVA-PA forward osmosis membranes of EX1, amount of PA distributed in the support unit 3 of the forward osmosis membranes of EX1 decreases in a direction away from the upper surface.

### Example 2 (EX2)

The forward osmosis membranes of E2 have a configuration of the second embodiment shown in FIG. 5 and were manufactured by procedures similar to those of EX1, except that in EX2, a combination of the aforesaid steps (a) and (c) of EX1 is first conducted before the formation of preform body in step (b).

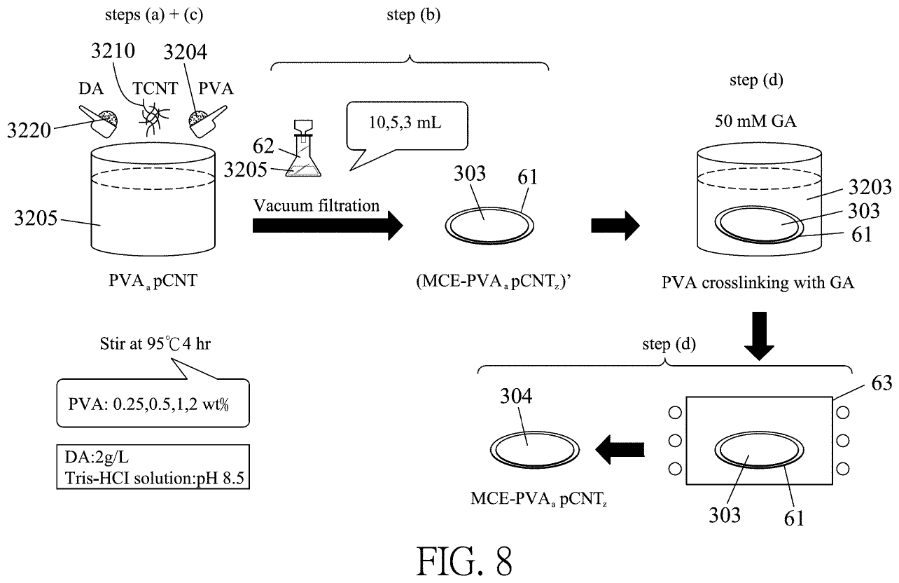

Referring to FIG. 8, to the buffer solution 3200 (see FIG. 6) containing dopamine (DA) hydrochloride 3220 and the TCNT dispersion 3210, PVA powder 3024 in a predetermined amount (i.e., 0.25 wt %, 0.5 wt %, 1.0 wt %, and 2.0 wt % based on a total weight of the buffer solution 3200 and the PVA powder 3024) was added, followed by stirring at 95° C. for 4 hours to evenly mix the PVA powder 3024 with the TCNT dispersion 3210, so as to obtain four PVAₐpCNT suspensions 3205 wherein “a” represents the PVA concentration and is selected from 0.25, 0.5, 1.0, or 2.0. Next, the step (b) as mentioned in EX1 is similarly performed. For each PVAₐpCNT suspension 3205, three MCE filter papers 61 were individually placed in the vacuum filter 62, and then a corresponding one of filtration amounts (i.e., 10 mL, 5 mL and 3 mL) of the PVAₐpCNT suspension 3205 was poured thereon, followed by performing vacuum filtration process. As such, twelve (MCE-PVAapCNTz)′ preform bodies 303 in which “a” represents the PVA concentration, while “z” represents the filtration amounts of the PVAₐpCNT suspension 3205 were obtained. Thereafter, each of the (MCE-PVAₐpCNT_{z})′ preform bodies 303 was dried in an oven (not shown) at 80° C. for 5 minutes. Subsequently, cross-linking PVA as mentioned in step (d) of EX1 was performed, in which the twelve (MCE-PVAₐpCNT_{z})′ preform bodies 303 were immersed in the glutaraldehyde (GA) solution 3203 for 30 minutes to allow cross-linking of PVA, and then dried in the oven 63 at 80° C. for 10 minutes, so as to obtain twelve (MCE-PVAₐpCNT_{z})′ films 304 of EX2.

Further referring to FIG. 5, by combining step (a) and step (c) before step (b) of forming the preform bodies 303, the resultant hydrophilic film 322 coated around each of the carbon nanotubes 321 is mainly configured as a single-layered structure including the first hydrophilic polymeric material (i.e., PDA), and the second hydrophilic polymeric material (i.e., PVA), and the second hydrophilic polymeric materials in the hydrophilic films 322 of adjacent ones of the nanostructures 32 are cross-linked.

After step (e) of forming the PA layer and removing MCE from the (MCE-PVAₐpCNT_{z})′ films 304, twelve PVAₐpCNT_{z}-PA forward osmosis membranes of EX2 including PVA_{0.25}pCNT₁₀-PA, PVA_{0.25}pCNT₅-PA, PVA_{0.25}pCNT₃-PA, PVA_{0.5}pCNT₁₀-PA, PVA_{0.5}pCNT₅-PA, PVA_{0.5}pCNT₃-PA, PVA_{1.0}pCNT₁₀-PA, PVA_{1.0}pCNT₅-PA, PVA_{1.0}pCNT₃-PA, PVA_{2.0}pCNT₁₀-PA, PVA_{2.0}pCNT₅-PA, and PVA_{2.0}pCNT₃-PA forward osmosis membranes were obtained.

### Comparative Example 1 (CE1)

The forward osmosis membranes of Comparative Example 1 (CE1) are manufactured by procedures similar to those of EX1, except that in CE1, the carbon nanotubes were not coated with polydopamine, but were subjected to dilution in step (a).

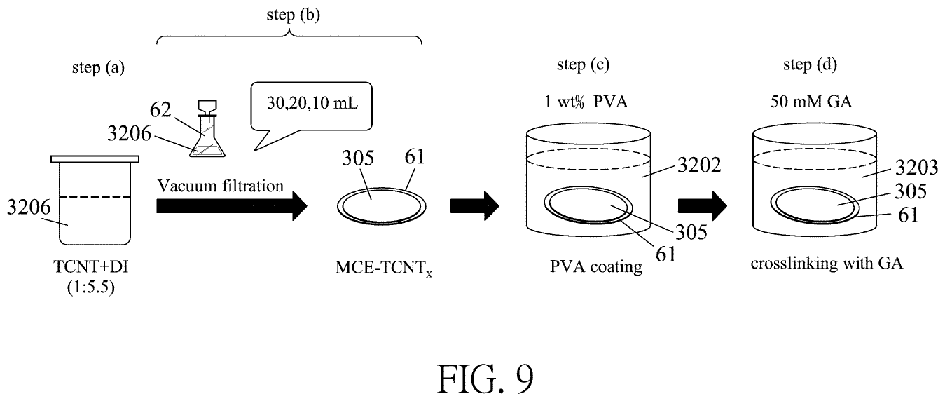

To be specific, referring to FIG. 9, in step (a), the TCNT dispersion 3210 was diluted with the deionized water at the weight ratio of the TCNT dispersion 3210 to the deionized water being 1:5.5, followed by sonication at 28° C. for at least 1 hour so that the TCNT dispersion 3210 is evenly mixed with the deionized water, thereby forming a TCNT suspension 3206. Next, the step (b) as mentioned in EX1 is performed, in which three MCE filter papers 61 were individually placed in the vacuum filter 62, and then a corresponding one of filtration amounts (i.e., 30 mL, 20 mL and 10 mL) of the TCNT suspension 3206 was poured thereon, followed by performing vacuum filtration, thereby forming three MCE-TCNTₓ preform bodies 305, in which “x” represents filtration amounts during the vacuum filtration process. Thereafter, steps (c) and (d) as mentioned in EX1 were performed, in which the MCE-TCNTₓ preform bodies 305 were immersed in the 1 wt % PVA aqueous solution 3202 to form the PVA layer, and then immersed in the GA solution 3203 containing 50 mM GA to allow cross-linking of PVA, thereby obtaining three MCE-TCNTₓ-PVA films.

After step (e) of forming the PA layer and removing MCE from the MCE-TCNTₓ-PVA films, three TCNTₓ/PVA-PA forward osmosis membranes of CE1, i.e., TCNT₃₀/PVA-PA, TCNT₂₀/PVA-PA, and TCNT₁₀/PVA-PA forward osmosis membranes, were obtained.

### Comparative Example 2 (CE2)

The forward osmosis membranes of Comparative Example 2 (CE2) are manufactured by procedures similar to those of CE1, except that in CE2, step (c) of forming PVA layer and step (d) of cross-linking PVA are omitted, and four filtration amounts (i.e., 30 mL, 20 mL, 10 mL and 3 mL) of the TCNT suspension 3206 were applied in step (b). Therefore, four TCNT_{X}-PA forward osmosis membranes of CE2, i.e., TCNT₃₀-PA, TCNT₂₀-PA, TCNT₁₀-PA, and TCNT₃-PA were obtained.

### Property Evaluation

### 1. Raman Spectroscopy

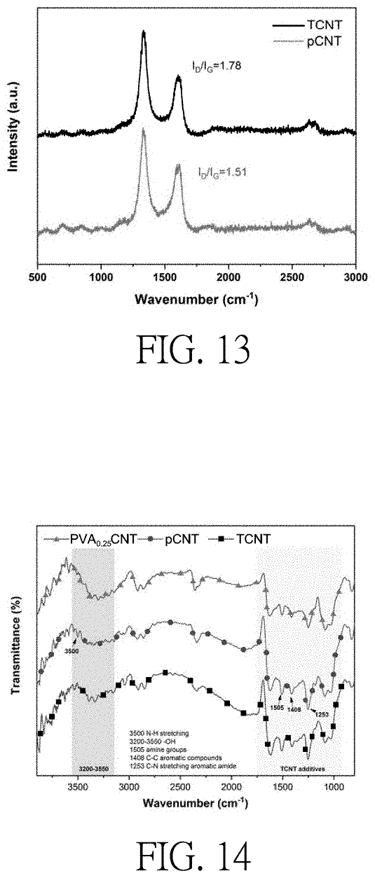

FIG. 13 is a graph showing Raman spectra of the support units 3 of the forward osmosis membranes of EX1 and CE1 before formation of the selective layer 5, i.e., the pCNT suspension 3021 of EX1 (denoted as pCNT curve) and the TCNT suspension 3206 of CE1 (denoted as TCNT curve). As shown in FIG. 13, the I_{D}/I_{G} ratio calculated from the pCNT curve for EX1 (1.51) was relatively lower than that calculated from the TCNT curve for CE1 (1.78), suggesting that compared to CE1, the support unit 3 of EX1 may have relatively less defects and thus exhibit superior mechanical strength.

### 2. Fourier Transform Infrared (FTIR) Spectroscopy

FIG. 14 is a graph showing Fourier Transform Infrared (FTIR) spectra of the support units of the forward osmosis membranes of EX1, EX2 and CE1 before formation of the selective layer, i.e., the PVA_{0.25}pCNT suspension 3205 of EX2 (denoted as PVApCNT curve), the pCNT suspension 3021 of EX1 (denoted as pCNT curve), and the TCNT suspension 3206 of CE1 (denoted as TCNT curve). As shown in FIG. 14, the pCNT curve for EX1 showed a transmittance signal at 3500 cm⁻¹ attributed to N—H stretching vibrations which was not observed in the TCNT curve for CE1, indicating PDA is coated around the carbon nanotubes in EX1. In addition, the curve of EX2 showed that a transmittance signal at 3500 cm⁻¹ attributed to N—H stretching vibrations was weaker compared with that of the pCNT curve for EX1, and transmittance signals from 3200 cm-1 to 3500 cm⁻¹ attributed to O—H stretching vibrations were stronger than those of the pCNT curve for EX1, suggesting that the surfaces of the carbon nanotubes in the PVA_{0.25}pCNT suspension 3205 of EX2 were successfully coated with PDA and PVA.

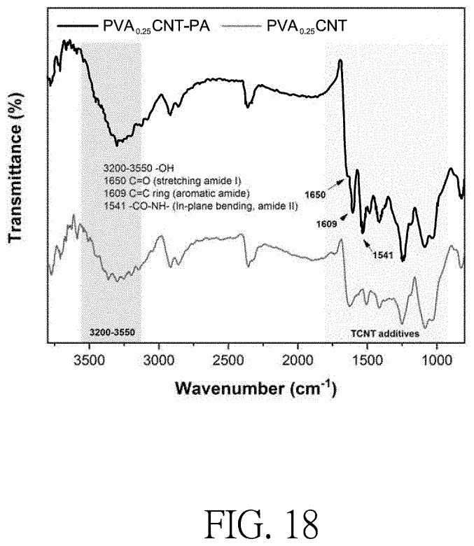

FIG. 18 is a graph showing a comparison between FTIR spectra of the PVA_{0.25}pCNT suspension 3205 and the PVApCNT-PA of EX2 (i.e., before and after forming the selective layer 5 made of polyamide (PA)). As shown in FIG. 18, in comparison to the signals of the PVApCNT curve, PVApCNT-PA curve showed an obvious transmittance signal at 1650 cm⁻¹ attributed to C═O (amide I) stretching vibrations, an obvious transmittance signal at 1541 cm⁻¹ attributed to CO—NH— (amide II) in-plane bending vibrations, and weaker transmittance signals from 3200 cm-1 to 3500 cm-1 attributed to O—H stretching vibrations of the PVA. These findings indicate that PA of the selective layer 5 contacts and binds to PVApCNT of EX2.

### 3. Transmission Electron Spectroscopy (TEM)

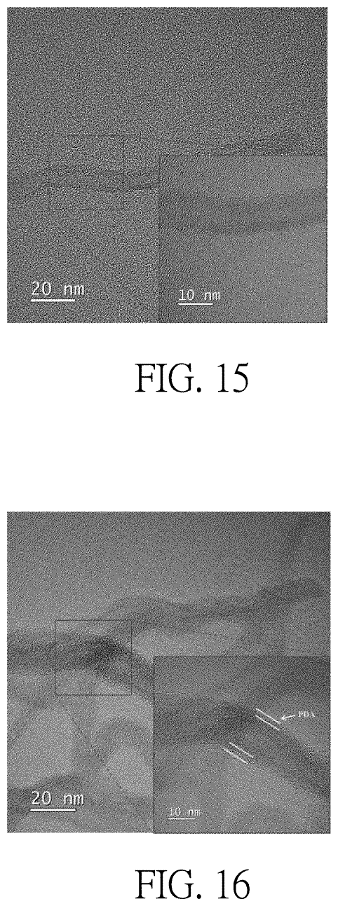

FIGS. 15 and 16 are TEM images of the TCNT suspension 3206 of CE1 and the pCNT suspension 3021 of EX1. As shown in FIGS. 15 and 16, the TCNT of CE1 had a diameter of approximately 10 nm, whereas the CNT of EX1 were coated with the PDA layer (i.e., the first hydrophilic polymeric layer 3221 as shown in FIG. 4), and such PDA layer is expected to improve water flux (Jw) of the forward osmosis membranes of EX1 during a forward osmosis performance test (to be described below).

### 4. Hydrophilicity

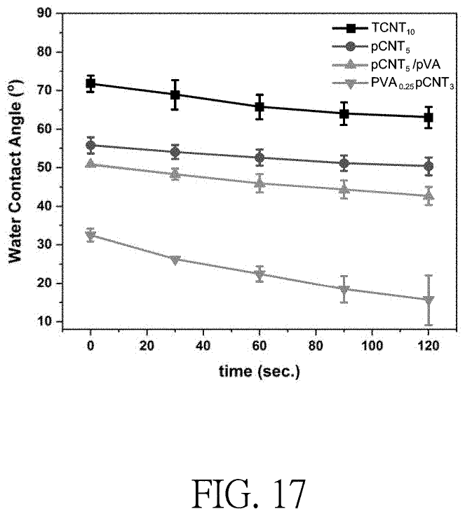

FIG. 17 is a graph showing water contact angle versus time of the MCE-TCNT₁₀ preform body 305 of CE1 (denoted as TCNT curve), the MCE-pCNT₅ preform body 301 of EX1 (denoted as pCNT curve), the MCE-pCNT₅/PVA film 302 of EX1 (denoted as pCNT/PVA curve), and the (MCE-PVA_{0.25}pCNT₃)′ film 304 of EX2 (denoted as PVApCNT curve). As shown in FIG. 17, the water contact angle values determined from the pCNT curve were lower than those determined from the TCNT curve, suggesting that the PDA-coated CNT of EX1 had increased contact area with water. In addition, the water contact angle values determined from the pCNT/PVA curve were lower than those determined from the pCNT curve, suggesting that the PVA layer (i.e., the second hydrophilic polymeric layer 3222 shown in FIG. 4) formed on the PDA-coated pCNT further increases the contact area of the PDA-coated CNT with water, which is expected to improve water flux (Jw) of the forward osmosis membranes of EX1 during the forward osmosis performance test. Moreover, the water contact angle values determined from the PVApCNT curve which were decreased from 34° to 16° in a time period of 120 seconds were lower than those determined from the pCNT/PVA curve, suggesting that the water flux (Jw) of the forward osmosis membranes of EX2 is expected to be higher than that of the forward osmosis membranes of EX1 during the forward osmosis performance test.

### 5. Scanning Electron Microscopy (SEM)

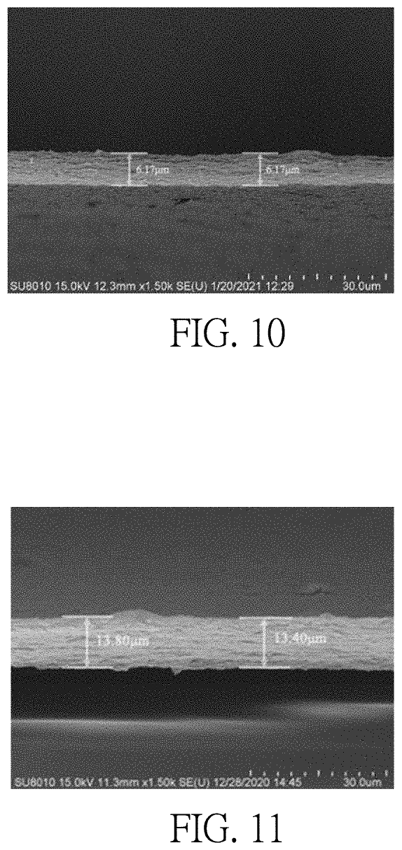

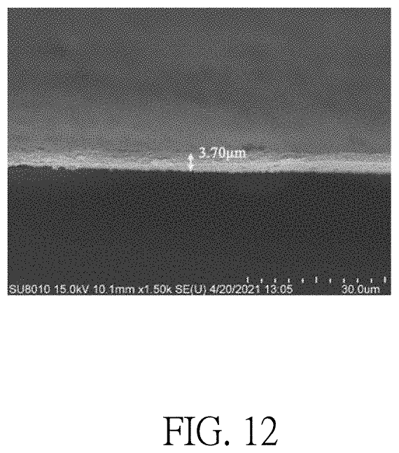

The thickness of each of the forward osmosis membranes of EX1, EX2, CE1 and CE2, as determined by SEM, were listed in Table 1 below. FIGS. 10 to 12 are SEM images which respectively showed that a cross-section of the pCNT₅/PVA-PA forward osmosis membrane of EX1 has a thickness of about 6.08±0.21 μm, a cross-section of the pCNT₁₀/PVA-PA forward osmosis membrane of EX1 has a thickness of about 13.60±0.30 μm, and a cross-section view of the PVA_{0.25}pCNT₃-PA forward osmosis membrane of EX2 with a thickness of about 3.70±0.13 μm.

TABLE 1

| Forward | | | | | Reverse |
|---|---|---|---|---|---|
| osmosis | General | Specific | Thickness | Water flux* | solute flux |
| membrane | configuration | configuration | (μm) | (Jw; Lm⁻²h⁻¹) | (Js; gm⁻²h⁻¹) |
| EX1 | pCNT_{y}/PVA-PA | pCNT₃₀/PVA-PA | 33.06 ± 0.26 | 10.86 | 1.62 |
| | | pCNT₂₀/PVA-PA | 24.00 ± 0.20 | 13.38 | 1.94 |
| | | pCNT₁₀/PVA-PA | 13.60 ± 0.30 | 15.80 | 2.77 |
| | | pCNT₅/PVA-PA | 6.08 ± 0.21 | 21.13 | 4.63 |
| EX2 | PVAₐpCNT_{z}-PA | PVA_{0.25}pCNT₁₀-PA | 13.60 ± 0.30 | — | — |
| | | PVA_{0.25}pCNT₅-PA | 6.08 ± 0.21 | — | — |
| | | PVA_{0.25}pCNT₃-PA | 3.70 ± 0.13 | 30.16 | 9.34 |
| | | PVA_{0.5}pCNT₁₀-PA | 13.60 ± 0.30 | — | — |
| | | PVA_{0.5}pCNT₅-PA | 6.08 ± 0.21 | — | — |
| | | PVA_{0.5}pCNT₃-PA | 3.70 ± 0.13 | 26.91 | 6.53 |
| | | PVA_{1.0}pCNT₁₀-PA | 13.60 ± 0.30 | 16.70 | 4.43 |
| | | PVA_{1.0}pCNT₅-PA | 6.08 ± 0.21 | 20.93 | 6.94 |
| | | PVA_{1.0}pCNT₃-PA | 3.70 ± 0.13 | 22.22 | 6.28 |
| | | PVA_{2.0}pCNT₁₀-PA | 13.60 ± 0.30 | — | — |
| | | PVA_{2.0}pCNT₅-PA | 6.08 ± 0.21 | — | — |
| | | PVA_{2.0}pCNT₃-PA | 3.70 ± 0.13 | 17.47 | 7.31 |
| CE1 | TCNTₓ/PVA-PA | TCNT₃₀/PVA-PA | 33.60 ± 0.26 | 8.83 | 2.44 |
| | | TCNT₂₀/PVA-PA | 24.00 ± 0.20 | 10.33 | 2.10 |
| | | TCNT₁₀/PVA-PA | 13.60 ± 0.30 | 14.25 | 3.09 |
| CE2 | TCNTₓ-PA | TCNT₃₀-PA | — | — | — |
| | | TCNT₂₀-PA | — | — | — |
| | | TCNT₁₀-PA | — | — | — |
| | | TCNT₃-PA | — | — | — |

*determined at 28° C., and NaCl concentration of 1.0M
“—”: not determined

### 6. Forward Osmosis Performance Test

The forward osmosis membranes of EX1, EX2, CE1 and CE2 were subjected to the forward osmosis performance test using a cross-flow system as disclosed in the U.S. Pat. No. 11,148,101 B2, so as to measure water flux (Jw) and reverse solute flux (Js) under forward osmosis (FO) mode and/or pressure-retarded osmosis (PRO) mode. To be specific, in the forward osmosis performance test, deionized water and 1 M of sodium chloride (NaCl) were respectively utilized as the feed solution and the draw solution, and the flow velocity, an effective area of each of the forward osmosis membranes, and the time period of the test were 25 cm/s, 16 cm², and 2 hours. The results are shown in Table 1 above.

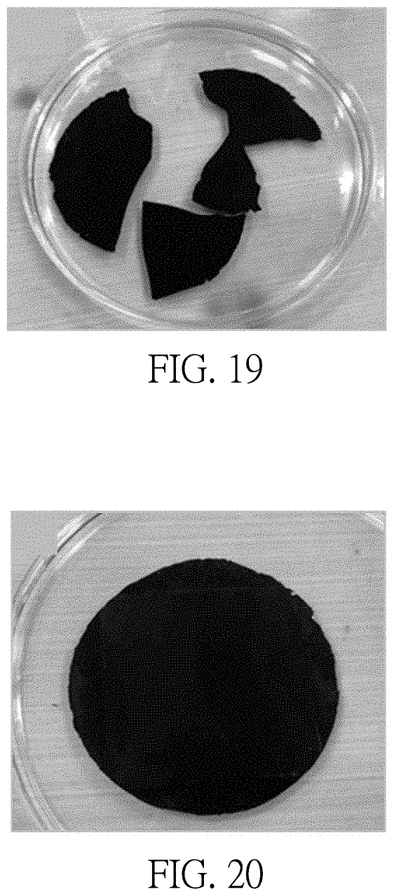

FIGS. 19 and 20 are photographs showing the appearance of the forward osmosis membranes TCNT₃-PA of CE2 and PVA_{0.25}pCNT₃-PA of EX2, respectively, after the forward osmosis performance test was conducted under the FO mode using the cross-flow system for 2 hours. As shown in FIGS. 19 and 20, after 2 hours of the forward osmosis performance test, the TCNT₃-PA of CE2 had been severely damaged, whereas the PVA_{0.25}pCNT₃-PA of EX2, despite having a thickness of only 3.70 μm, was still intact. These results confirm that the forward osmosis membrane of EX2, which was free of a non-woven fabric support layer used in the conventional forward osmosis membranes, was conferred with an excellent mechanical strength to withstand force generated from fluid flow in the cross-flow system for a long period of time.

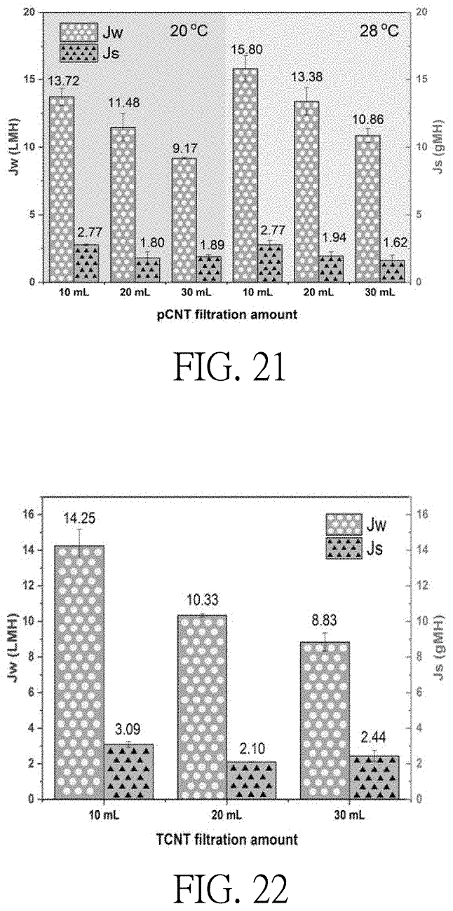

To evaluate the effect of temperature on the water flux (Jw) and reverse solute flux (Js), three forward osmosis membranes (pCNT₁₀/PVA-PA, pCNT₂₀/PVA-PA, and pCNT₃₀/PVA-PA) of EX1 were subjected to the forward osmosis performances test at 20° C. and 28° C. As shown in FIG. 21, for each of the forward osmosis membranes of EX1, the water flux (Jw) determined at 28° C. was higher than that determined at 20° C., suggesting that increased temperature improves the water flux (Jw) of the forward osmosis membranes of EX1. As such, the following forward osmosis performance tests for the forward osmosis membranes of EX1, EX2 and CE1 were all conducted at 28° C.

FIG. 22 is a bar graph showing the water flux (Jw) and reverse solute flux (Js) determined at 28° C. for three forward osmosis membranes of CE1, i.e., TCNTₓ/PVA-PA, where “x” represents the filtration amount of the TCNT suspension 3206. As shown in FIG. 22 and Table 1, the water flux (Jw) value and the thickness of TCNT₁₀/PVA-PA were respectively higher than and lower than those of TCNT₃₀/PVA-PA, indicating that a lower vacuum filtration amount would reduce the thickness of the forward osmosis membranes of CE1, but would increase the water flux thereof.

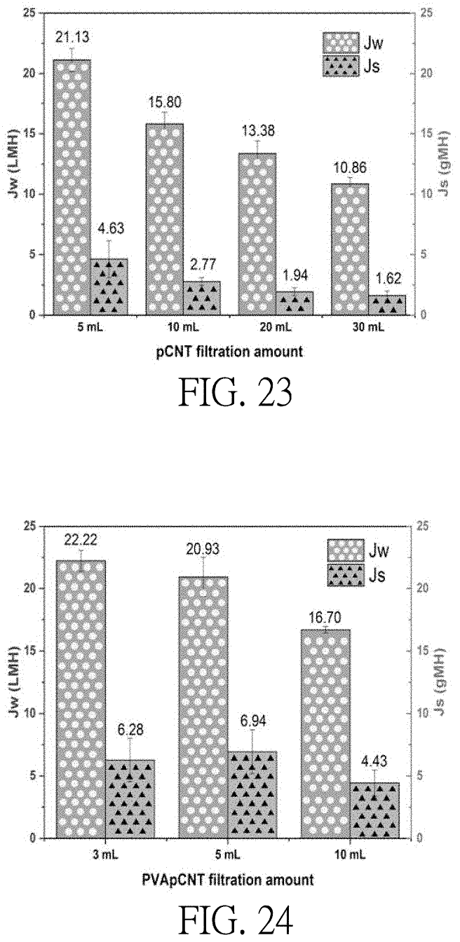

FIG. 23 is bar graph showing the water flux (Jw) and reverse solute flux (Js) determined at 28° C. for four forward osmosis membranes of EX1, i.e. pCNT_{y}/PVA-PA, where “y” represents the filtration amount of the pCNT suspension 3201. As shown in FIG. 23 and Table 1, the water flux (Jw) and reverse solute flux (Js) values of the four forward osmosis membranes of EX1 showed a trend which was substantially similar to those of the three forward osmosis membranes of CE1 as shown in FIG. 22, i.e., by decreasing the filtration amount of the pCNT suspension 3201 during preparation of the support unit 3, the thus obtained forward osmosis membranes of EX1 would have a reduced thickness and an increased water flux (Jw). For example, the pCNT₅/PVA-PA had a Jw value which was higher than that of pCNT₃₀/PVA-PA. In addition, when the forward osmosis membranes of EX1 and CE1 had identical thicknesses, e.g., both pCNT₁₀/PVA-PA and TCNT₁₀/PVA-PA had a thickness of 13.6 μm, the Jw value of the pCNT₁₀/PVA-PA (15.80 Lm⁻²h-=) was greater than that of the TCNT₁₀/PVA-PA (14.25 Lm⁻²h⁻¹), confirming that the PDA layer (i.e., the first hydrophilic polymeric layer 3221 as shown in FIG. 4) coated on the CNT improves the water flux (Jw) of the forward osmosis membranes of EX1 during the forward osmosis performance test.

FIG. 24 is a bar graph showing the water flux (Jw) and reverse solute flux (Js) determined at 28° C. for three forward osmosis membranes of EX2, i.e., PVA₁pCNT_{z}-PA, where “z” represents the filtration amount of the PVA₁pCNT suspension 3205. As shown in FIG. 24 and Table 1, the water flux (Jw) and reverse solute flux (Js) values of the three forward osmosis membranes of EX2 showed a trend which was substantially similar to those shown in FIGS. 22 and 23, i.e., by decreasing the filtration amount of the PVA₁pCNT suspension 3205 during preparation of the support unit 3, the thus obtained forward osmosis membranes of EX2 would have a reduced thickness and an increased water flux (Jw). For example, the PVA_{1.0}pCNT₃-PA had a Jw value which was higher than that of PVA_{1.0}pCNT₁₀-PA. In addition, when the forward osmosis membranes of EX2 and of EX1 had identical thicknesses, e.g., 13.6 μm for both PVA_{1.0}pCNT₁₀-PA and pCNT₁₀/PVA-PA, the Jw value of the PVA_{1.0}pCNT₁₀-PA of EX2 (16.70 Lm⁻²h⁻¹) was greater than that of the pCNT₁/PVA-PA (15.80 Lm⁻²h⁻¹), confirming the result of the hydrophilicity test as shown in FIG. 17, that is, the forward osmosis membranes of EX2 would exhibit a further improved water flux (Jw) as compared to that of the forward osmosis membranes of EX1 when determined under the FO mode.

FIG. 25 is a bar graph showing the water flux (Jw) and reverse solute flux (Js) determined at 28° C. for four forward osmosis membranes of EX2, i.e., pVAₐpCNT₃-PA, where “a” represents PVA concentration.

As shown in FIG. 25, the water flux (Jw) of the forward osmosis membranes of EX2 increased with decreasing PVA concentration. In particular, the PVA_{0.25}pCNT₃-PA had a relatively high Jw value (30.16 Lm⁻²h⁻¹), and a Js value of only 9.34 gm⁻²h⁻¹.

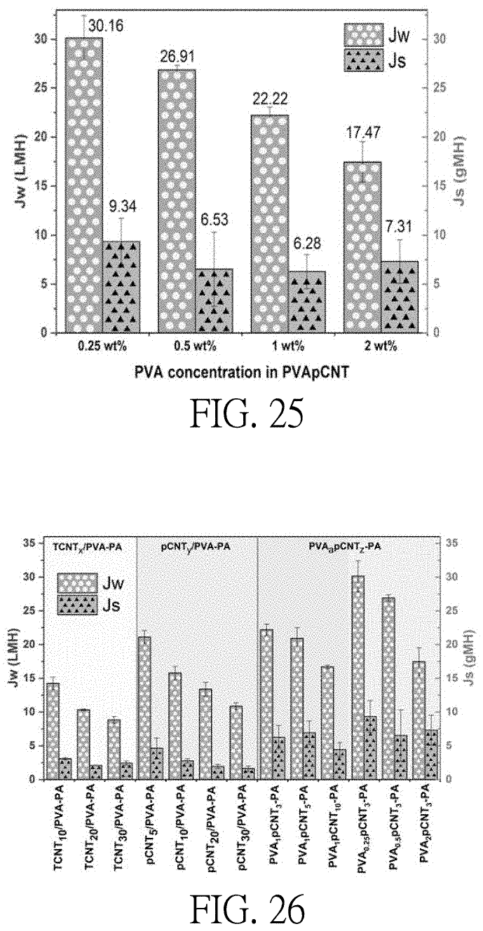

FIG. 26 is a bar graph summarizing a comparison of the water flux (Jw) and reverse solute flux (Js) determined at 28° C. for three forward osmosis membranes TCNTₓ/PVA-PA of CE1, four forward osmosis membranes pCNT_{y}/PVA-PA of EX1, and six forward osmosis membranes PVAₐpCNT_{z}-PA of EX2. As shown in FIG. 26 and Table 1, when the forward osmosis membranes had identical thicknesses (manufactured using identical filtration amounts, i.e., one of x, y and z is identical to another one thereof), the Jw values of the forward osmosis membranes of EX1 and EX2 were higher than those of the CE1, while the Jw values of the forward osmosis membranes of EX2 were even higher than those of the EX1.

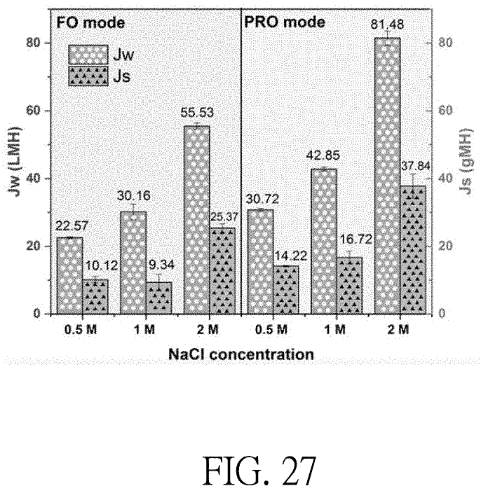

Moreover, as shown in FIG. 27 and Table 2 below, water flux (Jw) and reverse solute flux (Js) of the forward osmosis membrane PVA_{0.25}pCNT₃-PA of EX2 were determined under the FO mode and the PRO mode in a draw solution containing different salt (i.e., NaCl) concentrations. The water flux (Jw) of EX2 increased with increasing concentration of NaCl in the draw solution under the FO mode and the PRO mode. When the draw solution had a NaCl concentration of 2.0 M, the water flux (Jw) and the reverse solute flux (Js) of PVA_{0.25}pCNT₃-PA respectively reached 55.53 Lm⁻²h⁻¹ and 25.37 gm⁻²h⁻¹ under the FO mode, and respectively reached 81.48 Lm⁻²h⁻¹ and 37.84 gm⁻²h⁻¹ under the PRO mode. A ratio of the reverse solute flux to the water flux (hereinafter abbreviated as Js/Jw ratio) was approximately 0.46 under the FO mode.

TABLE 2

| | | | | | | | Concentration |
|---|---|---|---|---|---|---|---|
| | | | | | | | of NaCl in |
| Analyzed | FO mode | | | PRO mode | | | the draw |
| samples | Jw | Js | Js/Jw | Jw | Js | Js/Jw | solution* (M) |
| PVA_{0.25}pCNT₃-PA | 22.57 | 10.12 | 0.45 | 30.72 | 14.22 | 0.46 | 0.5 |
| | 30.16 | 9.34 | 0.31 | 42.85 | 16.72 | 0.39 | 1.0 |
| | 55.42 | 25.37 | 0.46 | 81.48 | 37.84 | 0.46 | 2.0 |
| HTI-TIA | 9.5 | 1.3 | 0.14 | 18.0 | 7.5 | 0.42 | 1.0 |

“*”: flow velocity for each measurement was 25 cm/s

As shown in Table 2 above, a commercially P available forward osmosis membrane, i.e., HTI-TIA, which was purchased from Hydration Technology Innovations LLC and reported in Zhao et al. (2017), Desalination, 413: 176-183, was also subjected to the forward osmosis performance test in the FO mode and the PRO mode using the draw solution having NaCl concentration of 1.0 M for comparison purpose. It is noted that when the draw solution had a NaCl concentration of 1.0 M, PVA_{0.25}pCNT₃-PA of EX2 had a Js/Jw ratio of 0.31 in the FO mode, which was slightly greater than that of HTI-TIA (i.e., 0.14), while the Js/Jw ratio in the PRO mode of PVA_{0.25}pCNT₃-PA of EX2 (i.e., 0.39) was less than that of HTI-TIA (i.e., 0.42). Therefore, the forward osmosis membrane PVA_{0.25}pCNT₃-PA of EX2 has an excellent selectivity and shows a great potential for applications in water purification.

Based on the description in the foregoing, it is noted that by virtue of the support unit 3 which includes the hydrophilic film 322 coated around the carbon nanotube 321 (i.e., the first hydrophilic polymeric layer 3221 formed by PDA and the second hydrophilic polymeric layer 3222 formed by cross-linked PVA cooperatively forming the hydrophilic film 322 as shown in FIG. 4, or the hydrophilic film 322 formed as a single layer structure as shown in FIG. 5 including PDA as the first hydrophilic polymeric materials and cross-linked PVA as the second hydrophilic polymeric materials), the forward osmosis membranes of EX1 and EX2, even without the non-woven fabric support layer disclosed in the prior art, still satisfy the requirements of having an excellent mechanical strength and a low water resistance. That is, by including the hydrophilic film 322, the contact angle between the support unit 3 and fluid (e.g., water) can be reduced to thereby increase water flux (Jw) of the forward osmosis membrane of the present disclosure (i.e., low water resistance). In addition, with the three-dimensional network structure formed from cross-linking of the second hydrophilic polymeric materials of the second hydrophilic polymeric layers 3222, the forward osmosis membrane of the present disclosure can have an excellent mechanical strength during fluid circulation and be able to withstand force generated by fluid flow for a long-term use.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A forward osmosis membrane having a low water resistance and an excellent mechanical strength, comprising:
a support unit including a plurality of nanostructures and having opposite first and second surfaces which are defined by said nanostructures, each of said nanostructures including a carbon nanotube and a hydrophilic film coated around said carbon nanotube, said hydrophilic film includes a first hydrophilic polymeric material and a second hydrophilic polymeric material, said second hydrophilic polymeric materials of said nanostructures being cross-linked; and
a selective layer covering and contacting said first surface of said support unit.

2. The forward osmosis membrane as claimed in claim 1, wherein for each of said nanostructures, said first hydrophilic polymeric material of said hydrophilic film is formed into a first hydrophilic polymeric layer that is coated around said carbon nanotube, and said second hydrophilic polymeric material is formed into a second hydrophilic polymeric layer that is coated around said first hydrophilic polymeric layer.

3. The forward osmosis membrane as claimed in claim 1, wherein for each of said nanostructures, said first hydrophilic polymeric material of said hydrophilic film is selected from the group consisting of polydopamine, poly(acrylic acid), polyaniline, polycaprolactone, and combinations thereof.

4. The forward osmosis membrane as claimed in claim 1, wherein for each of said nanostructures, said second hydrophilic polymer material is selected from the group consisting of poly(vinyl alcohol), polysulfone, polyether sulfone, and combinations thereof.

5. The forward osmosis membrane as claimed in claim 4, wherein said second hydrophilic polymeric materials of said nanostructures are cross-linked by a cross-linking agent that is selected from the group consisting of glutaraldehyde, N,N′methylenebisacrylamide, and a combination thereof.

6. The forward osmosis membrane as claimed in claim 1, wherein said selective layer is made of a polymeric material selected from the group consisting of polyamide, poly(amide-imide), poly(piperazine-amide), and combinations thereof.

7. The forward osmosis membrane as claimed in claim 1, which has a thickness ranging from 1.0 μm to 35.0 μm.

8. The forward osmosis membrane as claimed in claim 1, wherein said second surface of said support unit is an exposed surface.

9. The forward osmosis membrane as claimed in claim 1, which is free of a support layer made of non-woven fabric.
